(19) United States
(12) Patent Application Publication
(10) Pub. No.: US 2014/0042270 A1
(43) Pub. Date: Feb. 13, 2014

(54) STORAGE SYSTEM FOR STORING STATIC ELECTRICAL ENERGY IN ATMOSPHERE

(71) Applicant: JAMES CHYI LAI, Saint Paul, MN (US)

(72) Inventor: JAMES CHYI LAI, Saint Paul, MN (US)

(73) Assignee: NORTHERN LIGHTS SEMICONDUCTOR CORP., SAINT PAUL, MN (US)

(21) Appl. No.: 13/571,105

(22) Filed: Aug. 9, 2012

(51) Int. Cl. B64D 41/00

(52) U.S. Cl. 244/1 A

(57) ABSTRACT

Embodiments of the invention relate to a system and method for collecting and storing static electrical energy in the atmosphere. An embodiment of the system comprises a control station, an airborne energy harvester with a fuselage, a collecting unit, and a storage module. The control station wireless communicates with the airborne energy harvester to control the movement of the airborne energy harvester. The collecting unit is mounted on a surface of the fuselage to collect the static electrical energy in the atmosphere. The storage module is located inside of the fuselage and includes at least one magnetic capacitor. The static electrical energy collected by the collecting unit is transferred and stored in the at least one magnetic capacitor.

### TECHNICAL FIELD

Embodiments of the present invention relate to an apparatus and method for collecting and/or storing static electrical energy. A specific embodiment pertains to a storage system for storing static electrical energy in the atmosphere.

### BACKGROUND OF INVENTION

For years people have been attempting to find an effective and inexpensive energy source for various energy consuming facilities of modern day living, commerce, and technology. One of the prime concerns in utilizing the energy source is how to achieve environmentally protective, eco-friendly resources.

It is well known that, with respect to the earth, large quantities of electrical energy are present in the atmosphere and in lightning. A lightning discharge contains in the order of 10¹⁰ Joules of energy. Various ideas and concepts have been proposed for collection of lightning as a source of power. It has been estimated that the total electrical power of lightning across the earth is of the order of 10¹² watts. When a local build up of the electrical charge on the earth exceeds the local breakdown potential of the atmosphere a lightning discharge occurs. Lightning is, however, only a small portion of the total electrical activity of the atmosphere. There is a continual invisible flow of the charge from the Ionosphere to the earth day and night over the entire surface of the globe, which exceeds the global lightning power output by many times. Accordingly, it would be beneficial to collect and/or store this flow to provide useable electrical power.

### BRIEF SUMMARY

Embodiments of the present invention relate to a system and method for collecting and storing static electrical energy in the atmosphere. In a specific embodiment, the system for collecting and/or storing static electrical energy in the atmosphere comprises a control station, an airborne energy harvester, a collecting unit, and a storage module. The airborne energy harvester has a fuselage. The control station wirelessly communicates with the airborne energy harvester to control the movement of the airborne energy harvester. The collecting unit is mounted on a surface of the fuselage to collect the static electrical energy in the atmosphere. The storage module is located inside of the fuselage. The storage module includes at least one magnetic capacitor. The magnetic capacitor further comprises a first magnetic section, a second magnetic section and a dielectric section configured between the first magnetic section and the second magnetic section. The dielectric section is structured to store the electrical energy and has a thickness of at least 10 angstroms to reduce, and preferably prevent, electrical energy leakage. The static electrical energy collected by the collecting unit is transferred and stored in the at least one magnetic capacitor.

In an embodiment, the thickness of the dielectric section is at least 10 angstroms, at least 100 angstroms, and/or 100 angstroms.

In an embodiment, the fuselage has sharp edges on either side of the fuselage.

In an embodiment, an operating altitude of the airborne energy harvester is 1000 meters to 8000 meters.

In an embodiment, a power cable is attached to the collecting unit to transfer the static electrical energy to the at least one magnetic capacitor.

In an embodiment, a switch is posed between the power cable and the at least one magnetic capacitor.

In an embodiment, a controller is located inside of the fuselage to control the movement of the airborne energy harvester. The controller further comprises a communication system to wirelessly communicate with the control station. The controller further comprises a detector to detect a charging state of the at least one magnetic capacitor. When the charging state of the at least one magnetic capacitor is fully charged, the control station controls the controller to issue a control signal to the switch to disconnect a connection between the power cables and the at least one magnetic capacitor.

In an embodiment, a lift element is located inside of the fuselage, wherein the lift element includes one or more gas bag that is filled with lighter than air gas to generate a lift force that causes the airborne energy harvester to be airborne in the atmosphere.

In an embodiment, the collecting unit further comprises a plurality of rods mounted on the surface of the fuselage and protruding out toward the atmosphere.

In an embodiment, the storage module comprises a plurality of magnetic capacitors that are connected in parallel and fabricated in a substrate. The substrate further comprises a first connector and a second connector, such that the static electrical energy charges the magnetic capacitors through the first connector and the magnetic capacitors supplies the static electrical energy to an external device through the second connector.

### BRIEF DESCRIPTION OF DRAWINGS

In order to make the foregoing as well as other aspects, features, advantages, and embodiments of the present disclosure more apparent, the accompanying drawings are described as follows:

FIG. 1 is a schematic block diagram of a system for collecting and storing the static electrical energy in the atmosphere.

FIG. 2 is a schematic diagram of an airborne energy harvester according to an embodiment of the disclosure.

FIG. 3 is a schematic diagram of a magnetic capacitor to store static electrical energy in the atmosphere according to an embodiment of the disclosure.

FIG. 4 is a schematic diagram of a plurality of magnetic capacitors fabricated in a substrate together to store static electrical energy in the atmosphere according to an embodiment of the disclosure.

### DETAILED DISCLOSURE

Reference will now be made in detail to the various embodiments of the disclosure, one or more examples of which are illustrated in the figures. Each example is provided by way of explanation of the disclosure, and is not meant as a limitation of the disclosure. For example, features illustrated or described as part of one embodiment can be used in conjunction with other embodiments to yield yet a further embodiment. It is intended that the present disclosure includes such modifications and variations.

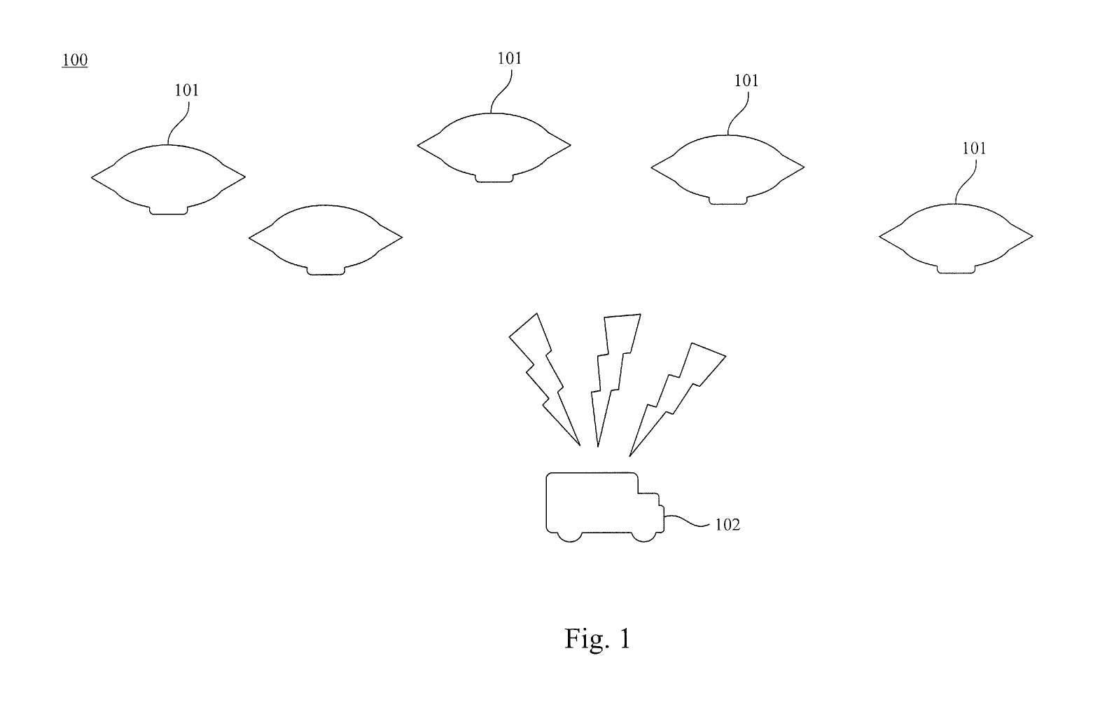

FIG. 1 is a schematic block diagram of a system for collecting and storing the static electrical energy in the atmosphere. The system 100 for collecting and storing the static electrical energy in the atmosphere includes one or more airborne energy harvester (AEH) 101 and a control station 102. In an embodiment, the control station 102 is in a vehicle, such as a car, but it could also be in a truck, a ship, a train, a tractor trailer truck, or even an airplane. The airborne energy harvester 101 is a remotely piloted vehicle (RPV) that carries ultra light weight energy storage module built with magnetic capacitors. The airborne energy harvester 101 is remotely controlled by the control station 102. The control station 102 preferably will include controls for the airborne energy harvester 101 yaw (steering), pitch, and/or roll. The airborne energy harvester 101 will hover in high lightning strike zones, acting as bridge between zones of positive electrical charge and zones of negative electrical charge.

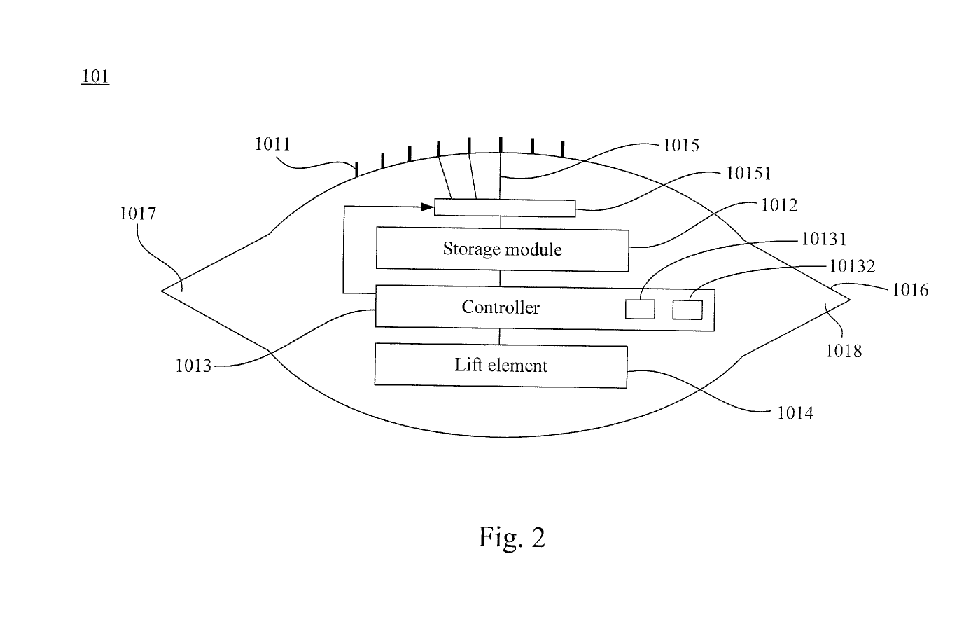

FIG. 2 is a schematic diagram of an airborne energy harvester according to an embodiment of the disclosure. The airborne energy harvester 101 includes one or more rods 1011, a storage module 1012, a controller 1013, and a lift element 1014. In an embodiment, the airborne energy harvester 101 may be an airship, including a blimp, a semi-rigid airship, or a rigid airship. The airborne energy harvester 101 may have aerodynamic stabilizers at the tail. The airborne energy harvester 101 has a fuselage 1016. The fuselage 1016 has sharp edges 1017 and 1018 on either side of the fuselage 1016, it will initiate atmospheric electrical discharges and store that energy in the storage module 1012.

The rods are mounted on the surface of the fuselage 1016 of the airborne energy harvester 101 and protrude toward the atmosphere. The storage module 1012, the controller 1013, and the lift element 1014 are positioned inside of the fuselage 1016 of the airborne energy harvester 101. The rods collect the static electrical energy in the atmosphere. The power cables 1015 transport energy collected by the rod 1011 to the storage module 1012. In an embodiment, the storage module 1012 also includes power conversion equipment that converts power from the form collected by the rods 1011 to a form better suited to charge the storage module 1012. For example, it may convert the high-voltage static electrical output to low-voltage static electrical output to charge the storage module 1012.

The controller 1013 provides a monitor and control system to permit a human operator to monitor and control the airborne energy harvester 101, for example, to adjust the airborne energy harvester 101 steering fins, to adjust the airborne energy harvester 101 hover altitude, or to stop charge the storage module 1012. In an embodiment, an operating altitude of the airborne energy harvester 101 is 1000 meters to 8000 meters to maximize the amount of static electrical energy available for capture. The controller 1013 may also include a communication system 10131 to communicate with the control station 102. The controller 1013 may also include a detector 10132 to detect the charging state of the storage module 1012. Data may be transferred between the control station 102 and the controller 1013 in the airborne energy harvester 101. The data may include, for example, the charging state of the storage module 1012 and the altitude of the airborne energy harvester 101. In an embodiment, a switch 10151 is disposed between the storage module 1012 and the power cables 1015. When the charging state of the storage module 1012 is fully charged, the control station 102 controls the controller 1013 to issue a control signal to the switch 10151 to disconnect a connection between the power cables 1015 and the storage module 1012. The storage module 1012 is not charged by the static electrical energy.

The lift element 1014 is lighter than air and is generating a lift force which caused the airborne energy harvester 101 to be airborne in the atmosphere. In an embodiment, the lift element 1014 includes one or more gas bag that is filled with lighter than air gas, like helium, hydrogen, hot air or any other lighter than air gas.

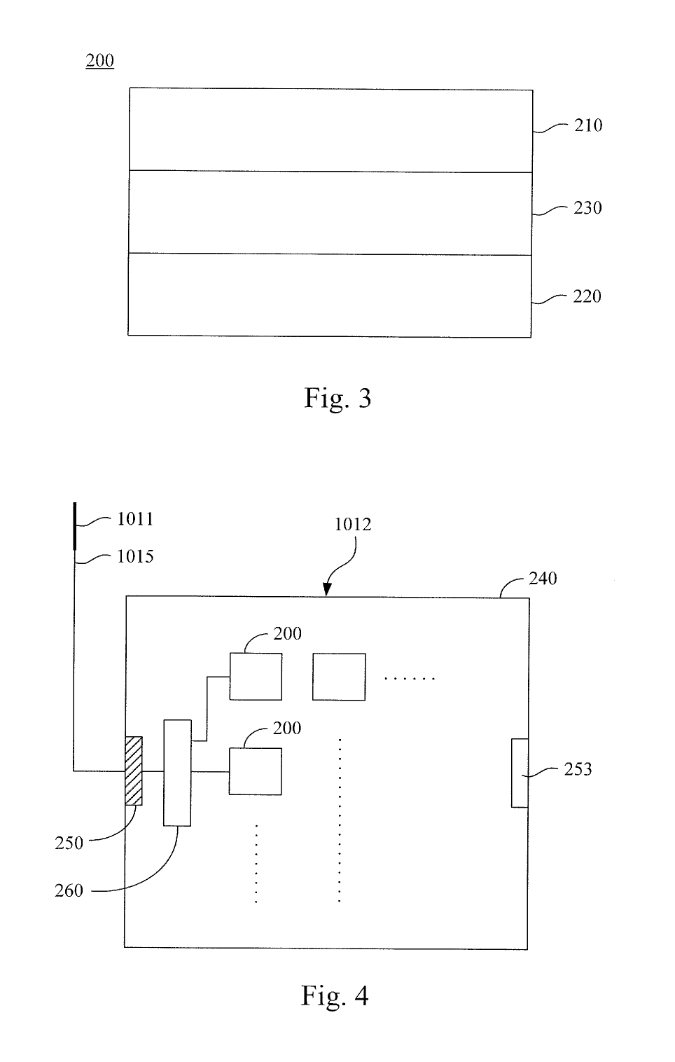

In an embodiment, the storage module 1012 is packaged in a box. The box has environmentally sealed cover for safety and protection from weather elements. The storage module 1012 is composed of one or more magnetic capacitor 200. The magnetic capacitor is constructed based on the GMC (Giant Magnetic Capacitance) theory. It has a capacitance 10⁶-10¹⁷ times larger than that of standard capacitor of equivalent dimensions and dielectric materials. A magnetic capacitor is an energy storage apparatus. FIG. 3 shows a schematic diagram of a magnetic capacitor to store the static electrical energy in the atmosphere according to an embodiment of the disclosure. A magnetic capacitor 200 has a first magnetic section 210, a second magnetic section 220, and a dielectric section 230 configured between the first magnetic section 210 and the second magnetic section 220. The dielectric section 230 is a thin film, and the dielectric section 230 is composed of dielectric material, such as BaTiO₃ or TiO₃. The dielectric section 230 is arranged to store electrical energy, and the first magnetic section 210 and the second magnetic section 220 are needed to generate the insulating-effect to reduce, or preferably prevent, current from passing through (i.e., electrical energy leakage). The dielectric section 230 further has a thickness at least 10 angstroms to reduce, or preferably prevent, electrical energy leakage. In an embodiment, the thickness of the dielectric section 230 is at least 10 angstroms, at least 100 angstroms, and/or 100 angstroms to reduce, or preferably prevent, electrical energy leakage.

In another embodiment, a plurality of magnetic capacitor 200 may be fabricated in a substrate 240 together to form the storage module 1012 as illustrated in FIG. 4. These magnetic capacitors 200 are connected in parallel and connected to the connector 250 and the connector 253. The connector 250 is formed in the substrate 240 to connect to the power cable 1015. The static electrical energy in the atmosphere collected by the rod 1011 is transferred to the storage module 1012 through power cable 1015. The connector 253 is also formed in the substrate 240 for supplying electrical energy to an external device. Furthermore, the storage module 1012 also includes power conversion equipment 260 that converts power from the form collected by the rods 1011 to a form better suited to charge the magnetic capacitors 200. For example, it may convert the high-voltage static electrical output to low-voltage static electrical output to charge the magnetic capacitors 200.

In operation, when a forecast indicates the weather conditions is suitable to collect the static electrical energy in the atmosphere, the control station 102 is deployed to a specific region and, upon arrival, The airborne energy harvester 101 are deployed. Rods 1011 collect the charges which are then stored directly in storage module 1012.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A system for collecting and storing static electrical energy in the atmosphere, comprising:
a control station;
an airborne energy harvester having a fuselage, wherein the control station wirelessly communicates with the airborne energy harvester to control the movement of the airborne energy harvester;
a collecting unit mounted on a surface of the fuselage to collect the static electrical energy in the atmosphere; and
a storage module located inside of the fuselage, wherein the storage module comprises at least one magnetic capacitor, each of the at least one magnetic capacitor comprising:
a first magnetic section;
a second magnetic section; and
a dielectric section configured between the first magnetic section and the second magnetic section, wherein the dielectric section is structured to store the static electrical energy and has a thickness of at least 10 angstroms;
wherein the static electrical energy collected by the collecting unit is transferred and stored in the at least one magnetic capacitor.

2. The system of claim 1, wherein the thickness of the dielectric section is at least 100 angstroms.

3. The system of claim 1, wherein the fuselage has sharp edges on either side of the fuselage.

4. The system of claim 1, wherein an operating altitude of airborne energy harvester is in a range of 1000 meters to 8000 meters.

5. The system of claim 1, wherein a power cable is attached to the collecting unit to transfer the static electrical energy to the at least one magnetic capacitor.

6. The system of claim 5, further comprising a switch disposed between the power cable and the at least one magnetic capacitor.

7. The system of claim 6, further comprising a controller located inside the fuselage to control the movement of the airborne energy harvester.

8. The system of claim 7, wherein the controller further comprises a communication system to wirelessly communicate with the control station.

9. The system of claim 7, wherein the controller further comprises a detector to detect a charging state of the at least one magnetic capacitor.

10. The system of claim 9, wherein when the charging state of the at least one magnetic capacitor is fully charged, the control station controls the controller to issue a control signal to the switch to disconnect a connection between the power cables and the at least one magnetic capacitor.

11. The system of claim 1, further comprising a lift element located inside of the fuselage, wherein the lift element includes one or more gas bag that is filled with lighter than air gas to generate a lift force which causes the airborne energy harvester to be airborne in the atmosphere.

12. The system of claim 1, wherein the collecting unit comprises a plurality of rods mounted on the surface of the fuselage and protruded out toward the atmosphere.

13. The system of claim 1, wherein the storage module comprises a plurality of magnetic capacitors that are connected in parallel and fabricated in a substrate.

14. The system of claim 13, wherein the substrate further comprises a first connector and a second connector, wherein the static electrical energy charges the plurality of magnetic capacitors through the first connector and the plurality of magnetic capacitors supplies the static electrical energy to an external device through the second connector.

15. The system of claim 1, wherein the thickness of the dielectric section is 100 angstroms.
